(19) United States
(12) Patent Application Publication
(10) Pub. No.: US 2024/0284496 A1
(43) Pub. Date: Aug. 22, 2024

(54) LOW LATENCY FRAME NOTIFICATION

(71) Applicant: NXP USA, Inc., Austin, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/583,437

(22) Filed: Feb. 21, 2024

Related U.S. Application Data
(60) Provisional application No. 63/486,424, filed on Feb. 22, 2023.
(60) Provisional application No. 63/487,436, filed on Feb. 28, 2023.

(51) Int. Cl. H04W 72/512; H04W 72/12

(52) U.S. Cl. CPC H04W 72/512; H04W 72/12

(57) ABSTRACT

Embodiments of a method and apparatus for wireless communications are disclosed. In an embodiment, a wireless device includes a wireless transceiver configured to communicate within a transmit opportunity (TXOP), where the wireless transceiver is further configured to receive a frame indicating a preemption allowance for low latency indication frame transmission from a second wireless device, and a controller configured to control the wireless transceiver to pause or resume data transmission within the TXOP in response to the frame indicating the preemption allowance for low latency indication frame transmission from the second wireless device.

### CROSS-REFERENCE TO RELATED APPLICATIONS

This application is entitled to the benefit of U.S. Provisional Patent Application Ser. No. 63/486,424, filed on Feb. 22, 2023, and U.S. Provisional Patent Application Ser. No. 63/487,436, filed on Feb. 28, 2023, each of which is incorporated by reference herein.

### BACKGROUND

Wireless communications devices, e.g., access points (APs) or non-AP devices can transmit various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). Some applications, for example, video surveillance or sharing applications, etc., require low latency (e.g., lower than 20 milliseconds) data transmission.

### SUMMARY

Embodiments of a method and apparatus for wireless communications are disclosed. In an embodiment, a wireless device includes a wireless transceiver configured to communicate within a transmit opportunity (TXOP), where the wireless transceiver is further configured to receive a frame indicating a preemption allowance for low latency indication frame transmission from a second wireless device, and a controller configured to control the wireless transceiver to pause or resume data transmission within the TXOP in response to the frame indicating the preemption allowance for low latency indication frame transmission from the second wireless device. Other embodiments are also disclosed.

In an embodiment, the wireless device includes a non-access point (AP) station (STA) device.

In an embodiment, the wireless transceiver is further configured to receive, from a wireless access point (AP), the frame indicating the preemption allowance for low latency indication frame transmission from the second wireless device.

In an embodiment, the wireless transceiver is further configured to transmit an uplink (UL) physical layer protocol data unit (PPDU) to the wireless AP within the TXOP.

In an embodiment, the wireless transceiver is further configured to receive, from the wireless AP, the frame indicating the preemption allowance for low latency indication frame transmission from the second wireless device after the UL PPDU is transmitted to the wireless AP.

In an embodiment, the wireless transceiver is further configured to receive a low latency frame from the second wireless device after a low latency indication (LLI) frame is transmitted from the second wireless device.

In an embodiment, the wireless transceiver is further configured to receive a frame indicating a preemption release, and the controller is further configured to resume data transmission within the TXOP using the wireless transceiver after the frame indicating the preemption release is received.

In an embodiment, the controller is further configured to resume data transmission within the TXOP using the wireless transceiver after a predefined timeout period expires since the frame indicating the preemption allowance for low latency indication frame transmission from the second wireless device without detecting data communications using the wireless transceiver.

In an embodiment, both the wireless device and the second wireless device are non-access point (AP) station (STA) devices.

In an embodiment, a low latency indication allowance (LIA) bit is set to a specific value in a physical layer (PHY) header of the frame indicating the preemption allowance for low latency indication frame transmission from the second wireless device.

In an embodiment, a low latency indication allowance (LIA) bit is set to a specific value in media access control (MAC) control information of the frame indicating the preemption allowance for low latency indication frame transmission from the second wireless device.

In an embodiment, the wireless transceiver is further configured to receive low latency buffered frame indications from a plurality of wireless devices using the same frame content, Modulation Coding Scheme (MCS), Number of Spatial Streams (Nss), or scrambling initial value.

In an embodiment, the wireless device is compatible with an Institute of Electrical and Electronics Engineers (IEEE) 802.11 protocol.

In an embodiment, the wireless device is a component of a multi-link device (MLD).

In an embodiment, a non-access point (AP) station (STA) device includes a wireless transceiver configured to communicate within a transmit opportunity (TXOP), where the wireless transceiver is further configured to receive, from a wireless AP, a frame indicating a preemption allowance for low latency indication frame transmission from a second non-AP STA device, where a low latency indication allowance (LIA) bit is set to a specific value in a physical layer (PHY) header of the frame indicating the preemption allowance for low latency indication frame transmission from the second wireless device, and a controller configured to control the wireless transceiver to pause or resume data transmission within the TXOP in response to the frame indicating the preemption allowance for low latency indication frame transmission from the second non-AP STA device.

In an embodiment, a method for wireless communications involves using a wireless transceiver of a wireless device, communicating within a transmit opportunity (TXOP), including receiving a frame indicating a preemption allowance for low latency indication frame transmission from a second wireless device and controlling the wireless transceiver to pause or resume data transmission within the TXOP in response to the frame indicating the preemption allowance for low latency indication frame transmission from the second wireless device.

In an embodiment, the wireless device includes a non-access point (AP) station (STA) device.

In an embodiment, receiving the frame indicating the preemption allowance for low latency indication frame transmission from the second wireless device includes receiving, from a wireless access point (AP), the frame indicating the preemption allowance for low latency indication frame transmission from the second wireless device.

In an embodiment, the method further includes using the wireless transceiver of the wireless device, transmitting an uplink (UL) physical layer protocol data unit (PPDU) to the wireless AP within the TXOP.

In an embodiment, the method further includes receiving a frame indicating a preemption release, and pausing or resuming data transmission within the TXOP using the wireless transceiver in response to the frame indicating the preemption allowance for low latency indication frame transmission from the second wireless device includes resuming data transmission within the TXOP using the wireless transceiver after the frame indicating the preemption release is received.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link communications system in accordance with an embodiment of the invention.

FIG. 3 depicts a frame exchange sequence diagram between an AP, a station (STA), and other STA.

FIG. 4 depicts a frame exchange sequence diagram between an AP, a STA, and other STA.

FIG. 5 depicts a frame exchange sequence diagram between an AP, a STA, and other STA.

FIG. 6 depicts a frame exchange sequence diagram between an AP, a non-Ultra High Reliability (UHR), and a UHR STA.

FIG. 7 depicts a frame exchange sequence diagram between an AP and a STA.

FIG. 8 depicts a frame exchange sequence diagram between an AP, a STA, and other STAs.

FIG. 9 depicts a frame exchange sequence diagram between an AP, a STA, and other STAs.

FIG. 10 depicts a frame exchange sequence diagram between an AP, a STA, and other STAs.

FIG. 11 depicts a frame exchange sequence diagram between an AP, a STA, and other STAs.

FIG. 12 depicts a frame exchange sequence diagram between an AP and STAs.

FIG. 13 depicts a wireless device in accordance with an embodiment of the invention.

FIG. 14 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

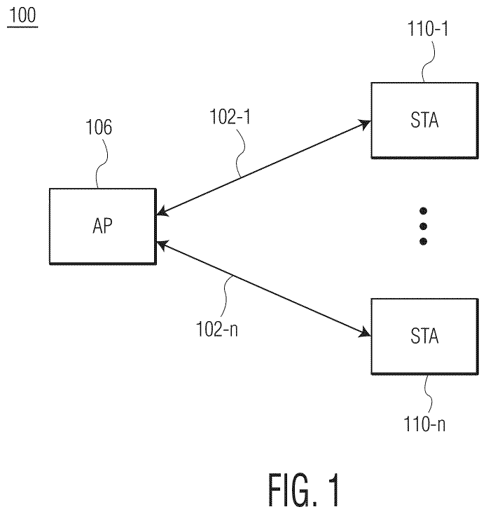

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with one STA, multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications links. In some embodiments, the wireless communications system 100 described with reference to FIG. 1 involves multi-link communications and the AP and the STA communicate through multiple communications links. Furthermore, the techniques described herein may also be applicable to each link of a multi-link communications system.

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon acknowledgement establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communications device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability communication protocol, or Institute of Electrical and Electronics Engineers (IEEE) 802.11bn communication protocol. Features of wireless communications and multi-link communication systems operating in accordance with the UHR communication protocol and/or next-generation communication protocols may be referred to herein as “non-legacy” features. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with pre-UHR protocols. The pre-UHR communication protocols (e.g., Extremely High Throughput (EHT) communication protocol that is compatible with IEEE 802.11be, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

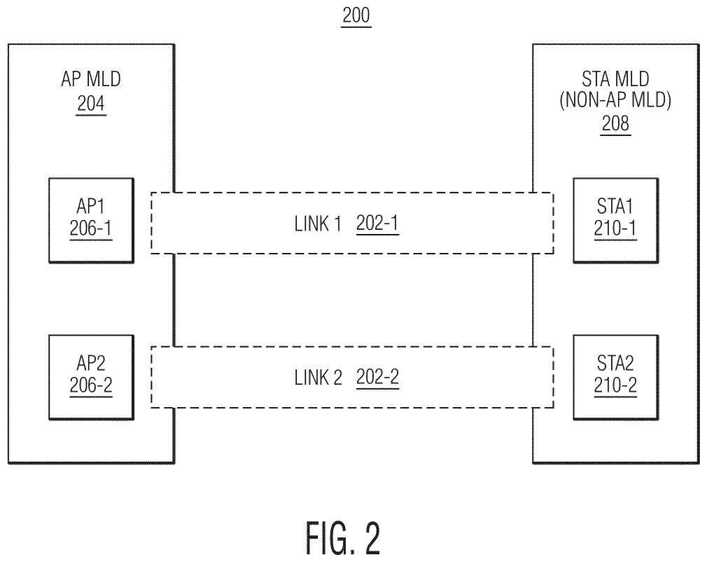

FIG. 2 depicts a multi-link communications system 200 in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD 208. The multi-link communications system is an embodiment of the wireless communications system 100 depicted in FIG. 1. In some embodiments, the multi-link communications system is a wireless communications system compatible with an IEEE 802.11 protocol. For example, the multi-link communications system may be a wireless communications system compatible with an IEEE 802.11be and with an IEEE 802.11bn protocols. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two radios, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., beaconing, association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with the IEEE 802.11be and with the IEEE 802.11bn protocols.

In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 206-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs.

In the embodiment depicted in FIG. 2, the non-AP STA multi-link device, implemented as STA MLD 208, includes two radios which are implemented as non-AP STAs 210-1 and 210-2. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., Physical Layer Protocol Data Units (PPDUs), Beacon frames, management frames, etc.) between a first wireless device (e.g., an AP, an AP MLD, an STA, or an STA MLD) and a second wireless device (e.g., an AP, an AP MLD, an STA, or an STA MLD). In some embodiments, a 20 MHz channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via multiple links 202-1 and 202-2, in other embodiments, the AP MLD 204 may communicate (e.g., wirelessly communicate) with the STA MLD 208 via more than two communication links or less than two communication links.

To accommodate low latency (LL) traffic, several issues (e.g., explicit preemption release signaling, preemption allowance indication in a PHY header, preemption on the Enhanced Multi-Link Single-Radio (EMLSR) link, preemption considering hidden node problem) need to be addressed.

Issue #1 is explicit preemption release signaling. For example, in order for a transmit opportunity (TXOP) holder to resume its transmission after the preemption event, the TXOP holder may need to receive a frame indicating the preemption release explicitly from an AP, which may cause additional signaling overhead. Even if a frame indicating the preemption release is transmitted by an AP after the preemption event, a TXOP holder may not receive the frame successfully, which may block the TXOP holder's transmission resumption.

Issue #2 is preemption allowance indication in a PHY header. For example, during a TXOP with the preemption event, a non-Ultra High Reliability (UHR) physical layer protocol data unit (PPDU) may need to be transmitted to non-UHR STAs. In this case, preemption allowance indication may need to be indicated in the non-UHR PPDU.

Issue #3 is preemption on the Enhanced Multi-Link Single-Radio (EMLSR) link. For example, the point coordination function (PCF) Interframe Space (PIFS) is not applicable when the TXOP holder or TXOP responder is the STA in EMLSR link. The PIFS may be used by the STA in EMLSR mode to decide whether it needs to cease the frame exchanges with the AP and the affiliated non-AP MLD returns back to listen on multiple link, i.e., if SIFS+aSlotTime+aRxPhyDelay (=PIFS+aRxPhyDelay) after the end of the last frame exchange the STA link EMLSR link does not detect the frame addressed to it, the non-AP MLD which the STA is affiliated with switches back to listening operation on multiple links.

Issue #4 is preemption considering hidden node problem. For example, a 3^{rd}-party STA's low latency frame transmission through preemption may collide with the TXOP holder's following frame exchange if the hidden node case happens.

### Example 1: Preemption Allowance Indication Implemented in a Downlink (DL) Frame (General Solution for UL TXOP Preemption)

In an embodiment, an AP (TXOP responder) may transmit a DL frame (e.g., a Block Acknowledgement (BA) frame) including the Low Latency Indication Allowance (LIA) bit set to True in the PHY header to a non-AP STA (TXOP holder). The LIA bit in a PPDU indicates whether a non-AP STA can transmit a Low Latency Indication (LLI) frame after the PPDU, to request preemption for its buffered low latency frame transmission. The Low Latency Indication Allowance (LIA) bit set to True in the DL frame can be decoded by the TXOP holder as well as non-TXOP holder 3^{rd} party STAs. 3^{rd} party STA that has buffered low latency frame may transmit a Low Latency Indication (LLI) frame after receiving the PPDU including the LL Indication Allowance (LIA) bit set to True. The AP that receives the LL Indication (LLI) frame from the 3^{rd} party STA can transmit a Trigger frame (e.g., a NDP Feedback Report Poll (NFRP) Trigger frame, a Buffer Status Report Poll (BSRP) Trigger frame, a Basic Trigger frame (TF), etc.) for scheduling of UL transmission of the low latency frame from the 3^{rd} party STA. In another example, the 3^{rd} party STA that sent the LLI frame can transmit the LL frame using contention-based channel access (e.g., EDCA) without receiving the Trigger frame from the AP. The AP that received the UL low latency frame from the 3^{rd} party STA and has DL low latency (DL LL) frame may transmit the DL low latency frame. The AP that does not receive the LL Indication (LLI) frame but has DL low latency frame may transmit the DL low latency frame. If the low latency frame is successfully transmitted by the 3^{rd} party STA and/or the AP or an LL Indication (LLI) frame is not received by the AP or the low latency frame using the contention-based channel access from the 3^{rd} party STA after the LLI frame is not successfully received by the AP, the AP may transmit a frame indicating the Preemption Release (Pr. Rel) to the non-AP STA (TXOP holder). The non-AP STA (TXOP holder) may resume its transmission if it receives the frame indicating the Preemption Release (Pr. Rel). The non-AP STA (TXOP holder) that receives a frame (e.g., BlockAck) with the LL Indication Allowance (LIA) bit set to True does not transmit a frame unless it receives the frame indicating the Preemption Release (Pr. Rel). The non-AP STA (TXOP holder) that has not received a frame (e.g., BlockAck) with the LL Indication Allowance (LIA) bit set to True or does not receive the frame (e.g., BlockAck) with the LL Indication Allowance (LIA) bit set to True after receiving a frame indicating the Preemption Release (Pr. Rel) may transmit a frame SIFS after the received frame (e.g., a Block Acknowledgement (BA) frame) not including the LL Indication Allowance (LIA) bit set to True.

In some embodiments, a non-AP STA that sent an LLI frame after a PPDU indicating the LIA bit set to True may transmit an LL frame to an AP using either EDCA channel access or trigger-based transmission based on at least one of the followings:
a. Announcement by the AP about which LL frame transmission method (e.g., EDCA or trigger-based) is used, through broadcast management frame e.g., Beacon.
b. Negotiation between the AP and the non-AP STA about which LL frame transmission method (e.g., EDCA or trigger-based) is used, through an individually addressed management frame.
c. Indication in each DL PPDU along with the LIA bit, about which LL frame transmission method (e.g., EDCA or trigger-based) is used.

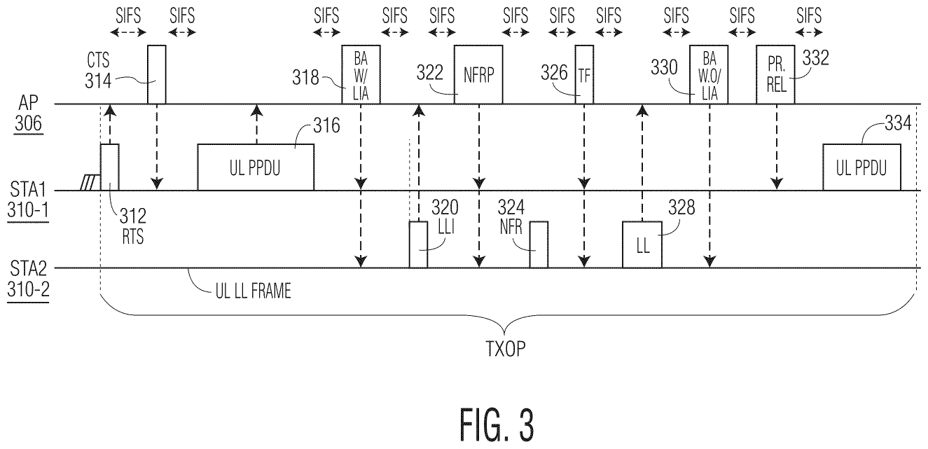

FIG. 3 depicts a frame exchange sequence diagram between an AP 306, a STA 310-1 with a TXOP, and other STA 310-2. In the embodiment depicted in FIG. 3, the AP 306 may be implemented the same as or similar to the AP 106 depicted in FIG. 1, while the STAs 310-1, 310-2 may be implemented the same as or similar to the STA 110-2, . . . , 110-n depicted in FIG. 1. In the frame exchange sequence diagram depicted in FIG. 3, a Request to Send (RTS) 312 is sent by the STA 310-1 to reserve the TXOP. After an SIFS, a Clear to Send (CTS) 314 is sent by the AP 306. After an SIFS, an uplink (UL) PPDU 316 is sent by the STA 310-1. The UL PPDU 316 optionally includes an indication of TXOP preemption to be allowed during the TXOP. After an SIFS, a Block Acknowledgement (BA) frame 318 including the Low Latency Indication Allowance (LIA) bit set to True in the PHY header is sent by the AP 306 to the non-AP STA (TXOP holder) 310-1. The Low Latency Indication Allowance (LIA) bit set to True in the DL frame can be decoded by the TXOP holder 310-1 as well as non-TXOP holder 3^{rd} party STAs. 3^{rd} party STA 310-2 that has buffered low latency frame may transmit a Low Latency Indication (LLI) frame 320. The AP 306 that receives the LL Indication (LLI) frame from the 3^{rd} party STA 310-2 can transmit a Trigger frame (e.g., a NDP Feedback Report Poll (NFRP) Trigger frame 322, a Basic Trigger frame (TF) 326, etc.), for example, for scheduling of UL transmission of the low latency frame from the 3^{rd} party STA 310-2. After an SIFS period once receiving the NDP Feedback Report Poll (NFRP) 322 from the AP 306, a NDP Feedback Report (NFR) frame 324 can be sent by the STA 310-2. After an SIFS period once receiving the TF 326 from the AP 306, a low latency (LL) frame 328 can be sent by the STA 310-2. The AP 306 that received the UL low latency frame 328 from the 3^{rd} party STA 310-2 and has DL low latency (DL LL) frame may transmit the DL low latency frame. If a low latency frame is successfully transmitted by the 3^{rd} party STA 310-2 and/or the AP 306 or an LL Indication (LLI) frame is not received by the AP 306, the AP 306 may transmit a frame indicating the Preemption Release (Pr. Rel) 332 to the non-AP STA (TXOP holder) 310-1. The non-AP STA (TXOP holder) 310-1 may resume its transmission by transmitting an UL PPDU 334 if it receives the frame indicating the Preemption Release (Pr. Rel). The non-AP STA (TXOP holder) 310-1 that receives a frame (e.g., BlockAck) with the LL Indication Allowance (LIA) bit set to True does not transmit a frame unless it receives the frame indicating the Preemption Release (Pr. Rel). The non-AP STA (TXOP holder) 310-1 that has not received a frame (e.g., BlockAck) with the LL Indication Allowance (LIA) bit set to True or does not receive the frame (e.g., BlockAck) with the LL Indication Allowance (LIA) bit set to True after receiving a frame indicating the Preemption Release (Pr. Rel) may transmit a frame SIFS after the received frame (e.g., a Block Acknowledgement (BA) frame) not including the LL Indication Allowance (LIA) bit set to True.

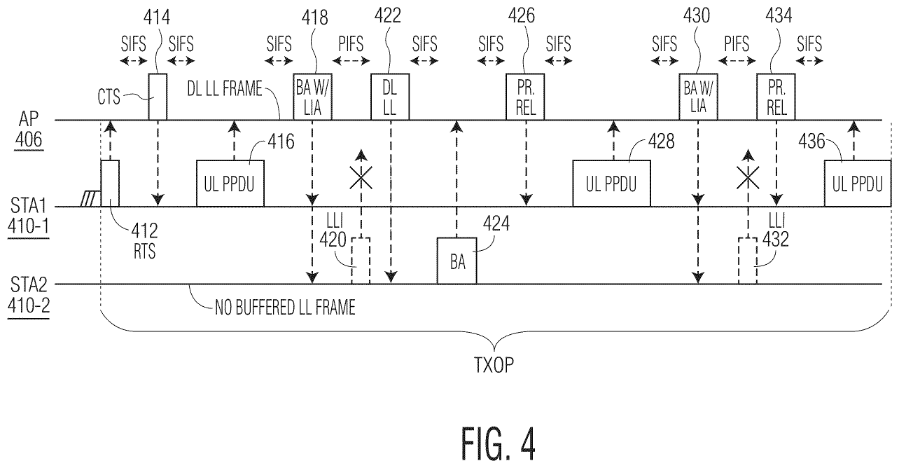

FIG. 4 depicts a frame exchange sequence diagram between an AP 406, a STA 410-1 with a TXOP, and other STA 410-2. In the embodiment depicted in FIG. 4, the AP 406 may be implemented the same as or similar to the AP 106 depicted in FIG. 1, while the STAs 410-1, 410-2 may be implemented the same as or similar to the STA 110-2, . . . , 110-n depicted in FIG. 1. In the frame exchange sequence diagram depicted in FIG. 4, a Request to Send (RTS) 412 is sent by the STA 410-1 to reserve the TXOP. After an SIFS, a Clear to Send (CTS) 414 is sent by the AP 406. After an SIFS, an uplink (UL) PPDU 416 is sent by the STA 410-1. The UL PPDU 416 optionally includes an indication of TXOP preemption to be allowed during the TXOP. After an SIFS, a Block Acknowledgement (BA) frame 418 including the Low Latency Indication Allowance (LIA) bit set to True in the PHY header is sent by the AP 406 to the non-AP STA (TXOP holder) 410-1. The Low Latency Indication Allowance (LIA) bit set to True in the DL frame can be decoded by the TXOP holder 410-1 as well as non-TXOP holder 3^{rd} party STAs. 410-2. In the embodiment depicted in FIG. 4, the 3^{rd} party STA 410-2 does not have buffered low latency frame and does not transmit a Low Latency Indication (LLI) frame 420. In the embodiment depicted in FIG. 4, the AP 406 that does not receive the LL Indication (LLI) frame but has DL low latency frame may transmit the DL low latency (LL) frame 422. After an SIFS period once receiving the DL LL frame 422 from the AP 406, a BA frame 424 can be sent by the STA 310-2. If a low latency frame is successfully transmitted by the 3^{rd} party STA 410-2 and/or the AP 406 or an LL Indication (LLI) frame is not received by the AP 406, the AP 406 may transmit a frame indicating the Preemption Release (Pr. Rel) 426 to the non-AP STA (TXOP holder) 410-1. The non-AP STA (TXOP holder) 410-1 may resume its transmission by transmitting an UL PPDU 428 if it receives the frame indicating the Preemption Release (Pr. Rel) 426. The non-AP STA (TXOP holder) 410-1 that receives a frame 430 (e.g., BlockAck) with the LL Indication Allowance (LIA) bit set to True does not transmit a frame (e.g., an UL PPDU 436) unless it receives the frame indicating the Preemption Release (Pr. Rel) 434. In the embodiment depicted in FIG. 4, the 3^{rd} party STA 410-2 does not have buffered low latency frame and does not transmit a Low Latency Indication (LLI) frame 432.

### Example 2: Implicit Preemption Release (for Issue #1)

In Example 1, the AP that preempts the TXOP by transmitting a frame indicating the LL Indication Allowance bit set to TRUE may need to transmit another frame, after low latency frame transmission/reception or checking whether receiving of the LL Indication frame, to indicate Preemption Release so that the non-AP STA (TXOP holder) can resume its transmission during the remaining TXOP. Both transmission of a first frame indicating the LL Indication Allowance bit set to TRUE and a second frame indicating the Preemption Release may be an additional overhead. If the non-AP STA (TXOP holder) that receives a frame (e.g., BlockAck) including the LL Indication Allowance bit set to True in the PHY header from the AP does not receive a frame indicating the Preemption Release, the non-AP STA may not be able to resume its transmission during the remaining TXOP. The frame indicating the Preemption Release may not be successfully received by the non-AP STA (TXOP holder) due to various reasons (e.g., interference, bad channel condition, etc.).

To solve the above issues, in some embodiments, a non-AP STA (TXOP holder) should be able to resume its transmission without receiving the explicit indication of the Preemption Release if no low latency frame transmission happens after receiving of the frame indicating the LL Indication Allowance bit set to TRUE. The non-AP STA (TXOP holder) that receives the frame indicating the LL Indication Allowance bit set to TRUE from the AP may check whether preemption for low latency transmission happens. In some embodiments, the non-AP STA (TXOP holder) shall monitor the channel to determine if a PHY-RXSTART.indication primitive is received from the PHY during a certain time period (e.g., PRTimeout). If such an event has not occurred during this time period, the non-AP STA (TXOP holder) may resume its frame transmission during the TXOP. In some embodiments, the certain time period (e.g., PRTimeout) can be larger than PIFS. For example, the certain time period (e.g., PRTimeout) can be calculated as 2×aSIFSTime+LL Indication frame transmission time+aRxPHYStartDelay+(2×aSlotTime).

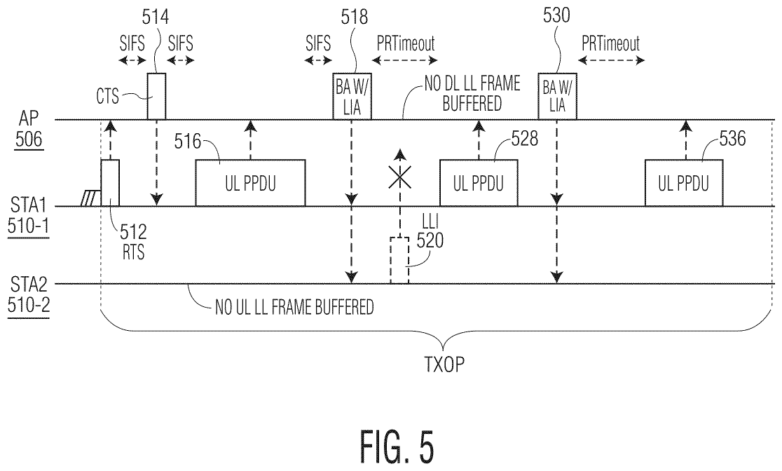

FIG. 5 depicts a frame exchange sequence diagram between an AP 506, a STA 510-1, and other STA 510-2. In the embodiment depicted in FIG. 5, the AP 506 may be implemented the same as or similar to the AP 106 depicted in FIG. 1, while the STAs 510-1, 510-2 may be implemented the same as or similar to the STA 110-2, . . . , 110-n depicted in FIG. 1. In the frame exchange sequence diagram depicted in FIG. 5, a Request to Send (RTS) 512 is sent by the STA 510-1 to reserve the TXOP. After an SIFS, a Clear to Send (CTS) 514 is sent by the AP 506. After an SIFS, an uplink (UL) PPDU 516 is sent by the STA 510-1. The UL PPDU 516 optionally includes an indication of TXOP preemption to be allowed during the TXOP. After an SIFS, a Block Acknowledgement (BA) frame 518 including the Low Latency Indication Allowance (LIA) bit set to True in the PHY header is sent by the AP 506 to the non-AP STA (TXOP holder) 510-1. The Low Latency Indication Allowance (LIA) bit set to True in the DL frame can be decoded by the TXOP holder 510-1 as well as non-TXOP holder 3^{rd} party STAs. 510-2. In the embodiment depicted in FIG. 5, the 3^{rd} party STA 510-2 does not have buffered low latency frame and does not transmit a Low Latency Indication (LLI) frame 520. In the embodiment depicted in FIG. 5, the AP does not have DL low latency frame buffered. After a PRtimeout period once receiving the BA frame 518 from the AP 506, the non-AP STA (TXOP holder) 510-1 may resume its transmission by transmitting an UL PPDU 528. The non-AP STA (TXOP holder) 510-1 that receives a frame 530 (e.g., BlockAck) with the LL Indication Allowance (LIA) bit set to True transmits a frame (e.g., an UL PPDU 536). In the embodiment depicted in FIG. 5, the 3^{rd} party STA 510-2 does not have buffered low latency frame.

### Example 3: Preemption Allowance Indication in the MAC Control Information (for Issue #2)

Some example issues are described as follows. UHR PPDU (indicating the LL Indication Allowance bit set to TRUE in the PHY header) cannot be decoded by a non-UHR STA such as an HE STA, an EHT STA. BlockAck (BA), Multi-STA BlockAck (M-BA) may contain the block acknowledgement information for an UHR STA and/or a non-UHR STA. BA/M-BA in an UHR PPDU may be too restrictive since the Trigger frame should schedule only UHR non-AP STAs to allow preemption operation in the following frames.

To solve the above issues, in some embodiments, the LL Indication Allowance can be indicated by a MAC control information (e.g., MAC control header, MAC control frame, etc.) for DL low latency frame transmission using preemption operation. The LL Indication Allowance can be indicated by e.g.,
the command and status (CAS) Control subfield;
a new A-Control subfield;
the existing field in the MAC header (e.g., Duration field set to a reserved value such as the Bit 14 and the Bit 15 set to 11);
one reserved bit in the BA frame (e.g., Compressed BA, Multi-STA BA, etc.);
MAC control frame body in the BA frame.

In a first case, an AP may indicate the Low Latency Indication Allowance set to TRUE in a frame through the MAC control information (e.g., in the MAC header of the non-High Throughput (HT) PPDU) if the frame is addressed to one or more non-UHR non-AP STAs or UHR non-AP STAs. A UHR non-AP STA that receives the frame including the Low Latency Indication Allowance set to TRUE in the MAC control information may transmit a Low Latency Indication frame if it has a buffered low latency frame. The AP that receives the Low Latency Indication frame may schedule UL transmission of LL frame from the UHR non-AP STA.

In a second case, an AP may indicate the Low Latency Indication Allowance set to TRUE in a frame through the PHY header of the UHR PPDU if the frame is addressed to only one or more UHR non-AP STAs. A UHR non-AP STA that receives the frame including the Low Latency Indication Allowance set to TRUE in the PHY header may transmit a Low Latency Indication frame if it has a buffered low latency frame. The AP that receives the Low Latency Indication frame may schedule UL transmission of LL frame from the UHR non-AP STA.

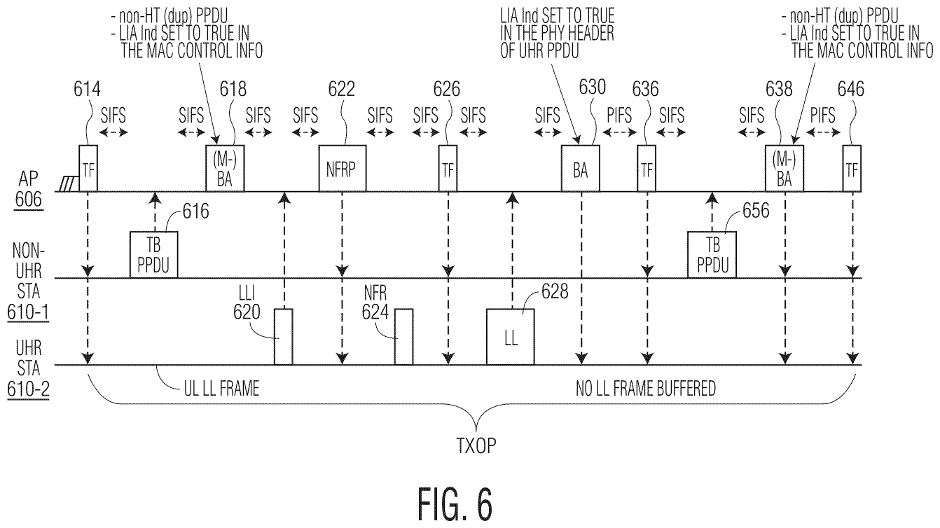

FIG. 6 depicts a frame exchange sequence diagram between an AP 606, a non-UHR STA 610-1, and a UHR STA 610-2. In the embodiment depicted in FIG. 6, the AP 606 may be implemented the same as or similar to the AP 106 depicted in FIG. 1, while the STAs 610-1, 610-2 may be implemented the same as or similar to the STA 110-2, . . . , 110-n depicted in FIG. 1. In the frame exchange sequence diagram depicted in FIG. 6, a Trigger frame (TF) 614 is sent by the AP 606. After an SIFS, a trigger based (TB) PPDU 616 is sent by the non-UHR STA 610-1. After an SIFS, a Block Acknowledgement (BA) frame 618 including the Low Latency Indication Allowance (LIA) bit set to True in the MAC control information (e.g., in the MAC header of the non-HT PPDU) is sent by the AP 606 to the non-UHR STA 610-1. The Low Latency Indication Allowance (LIA) bit set to True in the DL frame can be decoded by the non-UHR STA 610-1 as well as the UHR STA 610-2. The UHR STA 610-2 that has buffered low latency frame may transmit a Low Latency Indication (LLI) frame 620. The AP 606 that receives the LL Indication (LLI) frame from the UHR STA 610-2 can transmit a Trigger frame (e.g., a Null Data Packet (NDP) Feedback Report Poll (NFRP) Trigger frame 622, a Basic Trigger frame (TF) 626, etc.), for example, for scheduling of UL transmission of the low latency frame from the UHR STA 610-2. After an SIFS period once receiving the NDP Feedback Report Poll (NFRP) 622 from the AP 606, a NDP Feedback Report (NFR) frame 624 can be sent by the UHR STA 610-2. After an SIFS period once receiving the TF 626 from the AP 606, a low latency (LL) frame 628 can be sent by the UHR STA 610-2. The AP 606 that received the UL low latency frame 628 from the UHR STA 610-2 and may transmit a frame (e.g., BlockAck) 630 with the LL Indication Allowance (LIA) bit set to True in the PHY header of the UHR PPDU and a Basic Trigger frame (TF) 636 After a PIFS. The UHR STA 610-2 does not have buffered low latency frame to transmit. After an SIFS, a trigger based (TB) PPDU 656 is sent by the non-UHR STA 610-1. After an SIFS, a Block Acknowledgement (BA) frame 638 including the Low Latency Indication Allowance (LIA) bit set to True in the MAC control information (e.g., in the MAC header of the non-HT PPDU) is sent by the AP 606 to the non-UHR STA 610-1 and the UHR STA 610-2. After a PIFS, a Basic Trigger frame (TF) 646 is sent by the AP 606 to the non-UHR STA 610-1 and the UHR STA 610-2.

### Example 4: Allowing TXOP Holder's Low Latency Traffic Preemption within a DL EMLSR TXOP (for Issue #3)

In some embodiments, within a DL TXOP, the AP as the TXOP holder can preempt the TXOP by transmitting the low latency traffic frames to the responder. Within a DL TXOP, the AP as the TXOP holder can preempt the TXOP by transmitting the low latency traffic frames to a STA other than the TXOP responder. One option is that this means the non-AP MLD that the TXOP responder is affiliated with will switch to listening operation on multiple links. Another option is that the TXOP responder will wait for the frame exchanges with it after AP's low latency traffic frame exchanges. In order to help such operation, in some embodiments, the PHY header indicates the frame exchange of the low latency traffic. In some embodiments, if the TXOP responder detects a PPDU with such an indication from the TXOP holder that is not addressed to it, it will wait for the frame exchanges with it after AP's low latency traffic frame exchanges.

In some embodiments, if the AP is a TXOP holder and an EMLSR non-AP STA is a TXOP responder, the AP can indicate the TXOP to be preemptible using an initial control frame (e.g., multi-user (MU)-RTS Trigger frame, Buffer Status Report Poll (BSRP) Trigger frame). During the preemptible DL TXOP, the AP can transmit multiple frames to the EMLSR non-AP STA using a longer inter-frame space (e.g., PIFS), and the EMLSR non-AP STA does not switch to listening operation on multiple links during the preemptible TXOP unless the EMLSR non-AP STA receives either the indication of no more buffered frame for the non-AP STA (e.g., the More Data field set to 0 in the MAC header) or the indication of the end of the service period (e.g., the End of Service Period (EOSP) subfield set to 1 in the QoS Control field), or the preemptible TXOP ends. In some embodiments, within the preemptible DL TXOP, the AP as the TXOP holder can preempt the TXOP by transmitting the low latency traffic frames to the responder using a shorter inter-frame space (e.g., SIFS). In some embodiments, within the preemptible DL TXOP, the AP as the TXOP holder can preempt the TXOP by transmitting the low latency traffic frames to a STA other than the TXOP responder using a shorter inter-frame space (e.g., SIFS).

In a first option, in some embodiments, when the TXOP responder (STA in EMLSR mode) has low latency traffic frame to the TXOP holder, the TXOP responder sets an indication of its intention to preempt the TXOP for its low latency frame exchanges in the responding PPDU (in PHY header, MAC header, or the responding frame body). In some embodiments, the TXOP responder transmits the low latency traffic frame(s) in the PPDU with the indication of the preemption (to indicate the following preemption transmission after the current frame exchange) to the TXOP holder with SIFS inter-frame space after the end of the previous frame exchange. The indication may also indicate whether it is the last preemption frame exchange. In some embodiments, the TXOP holder that receives such indication will stop its following frame exchanges with SIFS inter-frame space. In some embodiments, the TXOP holder that does not detect such indication in the responding PPDU will continue its following frame exchanges with SIFS inter-frame space.

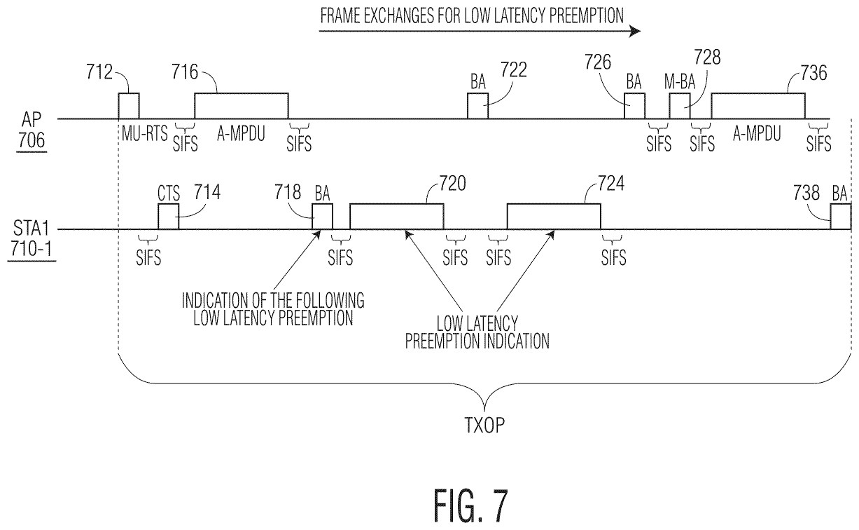

FIG. 7 depicts a frame exchange sequence diagram between an AP 706 and a STA 710-1. In the embodiment depicted in FIG. 7, the AP 706 may be implemented the same as or similar to the AP 106 depicted in FIG. 1, while the STA 710-1 may be implemented the same as or similar to the STA 110-2, . . . , 110-n depicted in FIG. 1. In the frame exchange sequence diagram depicted in FIG. 7, a multi-user (MU) Request to Send (RTS) 712 is sent by the AP 706. After an SIFS, a Clear to Send (CTS) 714 is sent by the STA 710-1. After an SIFS, an Aggregate MAC Protocol Data Unit (A-MPDU) 716 is sent by the AP 706. After an SIFS, a Block Acknowledgement (BA) frame 718 with an indication of the following low latency preemption is sent by the STA 710-1. After an SIFS, a frame 720 with low latency preemption indication is sent by the STA 710-1. After an SIFS, a Block Acknowledgement (BA) frame 722 is sent by the AP 706. After an SIFS, a frame 724 with low latency preemption indication is sent by the STA 710-1. After an SIFS, a Block Acknowledgement (BA) frame 726 is sent by the AP 706. After an SIFS, a M-BA Block frame 728 is sent by the AP 706. After an SIFS, an A-MPDU 736 is sent by the AP 706. After an SIFS, a Block Acknowledgement (BA) frame 738 is sent by the STA 710-1.

In a second option, in some embodiments, an inter-frame space that is more than SIFS and less than PIFS, e.g. SIFS+aSlotTime/2, is used by the TXOP holder to resume its frame exchanges if the TXOP responder does not have the low latency frames to transmit.

In a third option, in some embodiments, PIFS is used by the TXOP holder to resume its frame exchanges if the TXOP responder does not have the low latency frames to transmit. In some embodiments, the TXOP responder in EMLSR mode use SIFS+2*aSLotTime as inter-frame space to decide whether it needs to switch to listening operation in multiple links because of no frame addressed to it being received after the previous frame exchange, i.e., with SIFS+2*aSLotTime+aRxPHYStartDelay timeout where aRxPHYStartDelay is used to decoding the frame header.

Some examples of allowing 3rd-party STA's Low Latency Traffic Preemption within a DL EMLSR TXOP are described as follows. A first option, which can be used when the TXOP holder is an AP and the TXOP responder is an EMLSR STA, is described as follows. The TXOP holder (AP) may poll whether the 3^{rd}-party STAs have buffered low latency frames or poll the buffered low latency frames of the 3^{rd}-party STAs if the TXOP holder finish one of its frame exchanges and the TXOP responder finishes its low latency frame exchanges (if exists). In some embodiments, the PPDU that carries the polling frame (Trigger frame) or the polling frame indicates the low latency preemption operation and whether it is the last frame exchange of low latency preemption. In some embodiments, one option is that the TXOP responder will stay in the frame exchanges operation in the link and receive the frames from the TXOP holder after the indication of low latency preemption operation disappear. In some embodiments, another option is that the TXOP responder will switch to listening operation after the indication of low latency preemption operation. In some embodiments, a 3^{rd}-party STA that has buffered low latency frames waits for AP's polling within the TXOP that the 3^{rd}-party STA is neither the TXOP holder nor the TXOP responder of the TXOP. In another example, an AP may transmit a DL PPDU with the Low Latency Indication Allowance bit set to True without transmitting the polling frame. When a 3^{rd}-party STA that has a buffered low latency frame receives the DL PPDU with the LIA bit set to True, the 3^{rd}-party STA may transmit Low Latency Indication frame SIFS after the PPDU or SIFS after an immediate response frame sent by a EMLSR STA that is a TXOP responder. The TXOP responder may stay in the frame exchanges operation during the TXOP (or the service period) even though the TXOP responder does not receive a frame addressed to it within the PIFS, when the TXOP responder receives a DL PPDU with the LIA bit set to True.

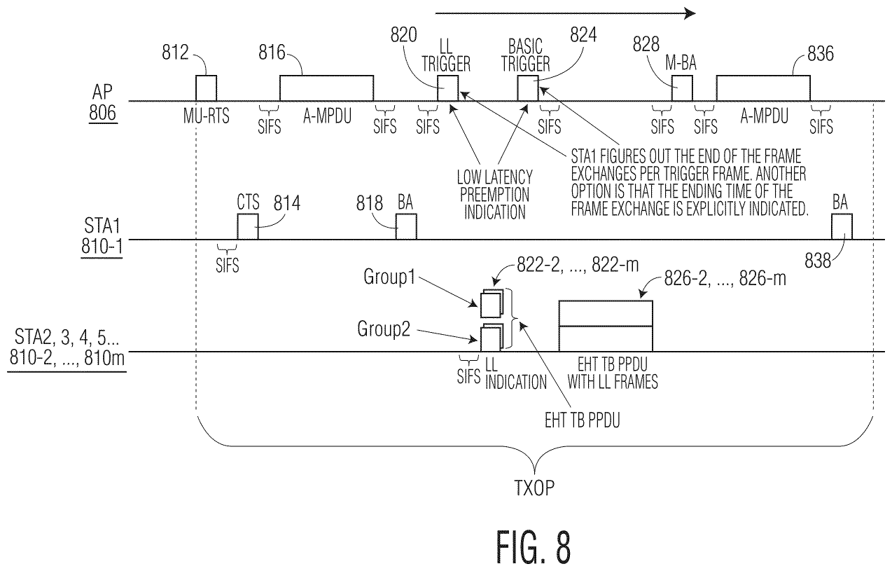

FIG. 8 depicts a frame exchange sequence diagram between an AP 806, a STA 810-1, and other STAs 810-2, . . . , 810-m, where m is a positive integer that is greater than one. In the embodiment depicted in FIG. 8, the AP 806 may be implemented the same as or similar to the AP 106 depicted in FIG. 1, while the STAs 810-1, . . . , 810-m may be implemented the same as or similar to the STA 110-2, . . . , 110-n depicted in FIG. 1. In the frame exchange sequence diagram depicted in FIG. 8, a multi-user (MU) Request to Send (RTS) 812 is sent by the AP 806. After an SIFS, a Clear to Send (CTS) 814 is sent by the STA 810-1. After an SIFS, an A-MPDU 816 is sent by the AP 806. After an SIFS, a Block Acknowledgement (BA) frame 818 with an indication of the following low latency preemption is sent by the STA 810-1. After an SIFS, a low latency (LL) trigger frame 820 with low latency preemption indication is sent by the AP 806. After an SIFS, frames 822-2, . . . , 822-m with LL indication are sent by the other STAs 810-2, . . . , 810-m. After an SIFS, a basic trigger frame 824 with low latency preemption indication is sent by the AP 806. For example, the STA 810-1 figures out the end of the frame exchanges per Trigger frame. Another option is that the ending Time of the frame exchange is explicitly indicated. After an SIFS, EHT TB PPDU (or UHR TB PPDU) with LL frames 826-2, . . . , 826-m sent by the other STAs 810-2, . . . , 810-m. After an SIFS, a M-BA Block frame 828 is sent by the AP 806. After an SIFS, an A-MPDU 836 is sent by the AP 806. After an SIFS, a Block Acknowledgement (BA) frame 838 is sent by the STA 810-1.

Some examples of Low Latency Traffic Preemption within a UL EMLSR TXOP are described as follows. In some embodiments, the TXOP responder (AP) indicates whether it want to preempt the TXOP for its low latency frame transmission or poll the 3^{rd}-party STA's buffered low latency traffic indication (of the low latency traffic frames) after one of frame exchanges initiated by the TXOP holder. In some embodiments, the PPDU that carries the polling frame (Trigger frame) or the polling frame indicates the low latency preemption operation and whether it is the last frame exchange of low latency preemption. The low latency traffic frames of a 3^{rd}-party STA can be transmitted through polling by the AP. In some embodiments, the polling can be AP's poll about whether the 3^{rd}-party STA has buffered low latency traffic or poll the low latency frame transmission. In some embodiments, the PPDU of the 3^{rd}-party STA is TB PPDU. In some embodiments, the 3^{rd}-party STAs are allocated to different groups where each group has a specific resource unit (RU), each group may have multiple 3^{rd}-party STAs. In some embodiments, the TXOP holder stops its frame exchanges if it receives a BA with the indication of low latency preemption. In some embodiments, the TXOP holder resumes its frame exchange after the last preempted frame exchange.

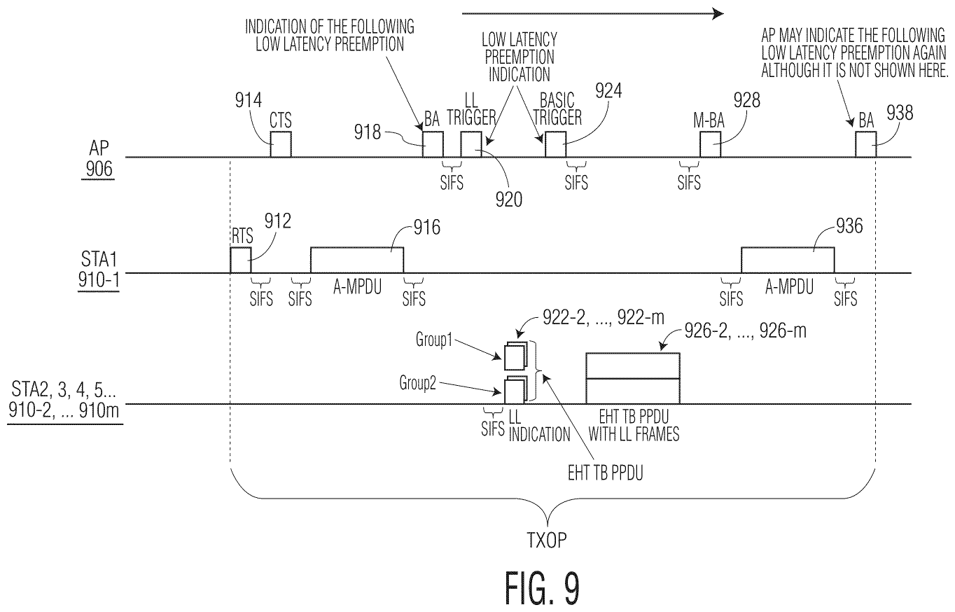

FIG. 9 depicts a frame exchange sequence diagram between an AP 906, a STA 910-1, and other STAs 910-2, . . . , 910-m, where m is a positive integer that is greater than one. In the embodiment depicted in FIG. 9, the AP 906 may be implemented the same as or similar to the AP 106 depicted in FIG. 1, while the STAs 910-1, . . . , 910-m may be implemented the same as or similar to the STA 110-2, . . . , 110-n depicted in FIG. 1. In the frame exchange sequence diagram depicted in FIG. 9, an RTS 912 is sent by the STA 910-1 to reserve the TXOP. After an SIFS, a CTS 914 is sent by the AP 906. After an SIFS, an A-MPDU 916 is sent by the STA 910-1. After an SIFS, a BA frame 918 is sent by the AP 906. After an SIFS, a low latency (LL) trigger frame 920 with low latency preemption indication is sent by the AP 906. After an SIFS, frames 922-2, . . . , 922-m with LL indication are sent by the other STAs 910-2, . . . , 910-m. After an SIFS, a basic trigger frame 924 with low latency preemption indication is sent by the AP 906. After an SIFS, EHT TB PPDU (or UHR TB PPDU) with LL frames 926-2, . . . , 926-m sent by the other STAs 910-2, . . . , 910-m. After an SIFS, a M-BA Block frame 928 is sent by the AP 906. After an SIFS, an A-MPDU 936 is sent by the STA 910-1. After an SIFS, a Block Acknowledgement (BA) frame 938 is sent by the AP 906.

### Example 5: Low Latency Traffic Preemption by TXOP Holder and Responder

In some embodiments, when both the TXOP holder and the TXOP responder have the low latency traffic frames, the TXOP holder sends its low latency traffic frames after the TXOP responder's low latency preemption unless the TXOP explicitly indicates that it will do the low latency frame exchanges after the current frame exchange.

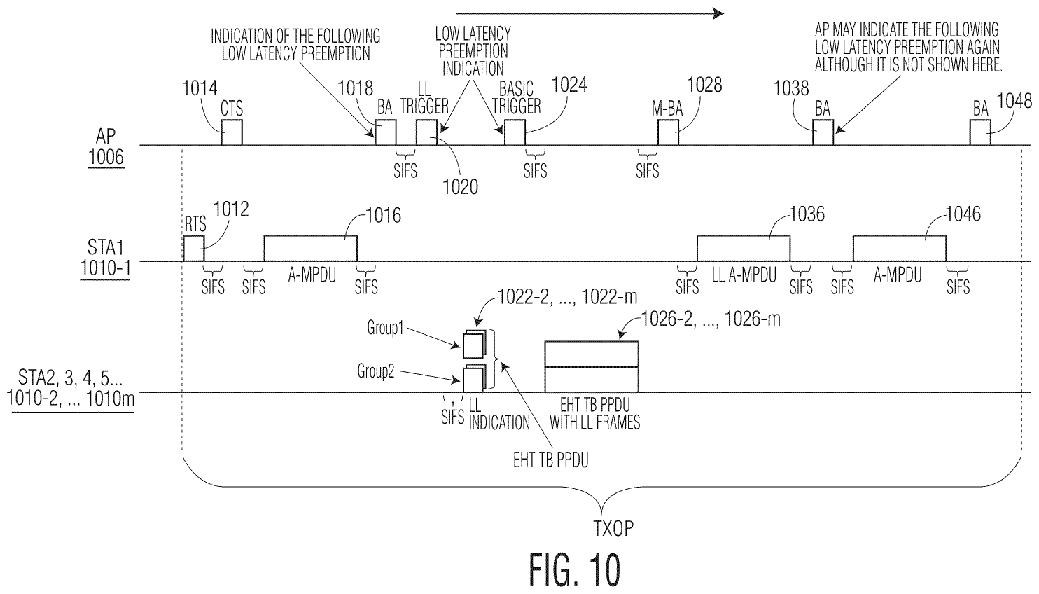

FIG. 10 depicts a frame exchange sequence diagram between an AP 1006, a STA 1010-1, and other STAs 1010-2, . . . , 1010-m, where m is a positive integer that is greater than one. In the embodiment depicted in FIG. 10, the AP 1006 may be implemented the same as or similar to the AP 106 depicted in FIG. 1, while the STAs 1010-1, . . . , 1010-m may be implemented the same as or similar to the STA 110-2, . . . , 110-n depicted in FIG. 1. In the frame exchange sequence diagram depicted in FIG. 10, an RTS 1012 is sent by the STA 1010-1 to reserve the TXOP. After an SIFS, a CTS 1014 is sent by the AP 1006. After an SIFS, an A-MPDU 1016 is sent by the STA 1010-1. After an SIFS, a BA frame 1018 is sent by the AP 1006. The BA frame 1018 indicates the following low latency preemption. After an SIFS, a low latency (LL) trigger frame 1020 with low latency preemption indication is sent by the AP 1006. After an SIFS, frames 1022-2, . . . , 1022-m with LL indication are sent by the other STAs 1010-2, . . . , 1010-m. After an SIFS, a basic trigger frame 1024 with low latency preemption indication is sent by the AP 1006. After an SIFS, EHT TB PPDU with LL frames 1026-2, . . . , 1026-m sent by the other STAs 1010-2, . . . , 1010-m. After an SIFS, a M-BA Block frame 1028 is sent by the AP 1006. After an SIFS, an LL A-MPDU 1036 is sent by the STA 1010-1. After an SIFS, a Block Acknowledgement (BA) frame 1038 is sent by the AP 1006. The AP 1006 may indicate the following low latency preemption again although it is not shown here. After an SIFS, an LL A-MPDU 1046 is sent by the STA 1010-1. After an SIFS, a Block Acknowledgement (BA) frame 1048 is sent by the AP 1006.

### Example 6: LL Buffered Frame Indication without Polling

In some embodiments, without AP's polling, multiple 3^{rd}-party STAs may raise the request for its buffered frame transmission. In some embodiments, in order to let the AP to figure out the LL buffered frame indication, the PPDU transmitted by the multiple 3^{rd}-party STAs need to be exactly same: same PPDU format, same frame content, same scrambling initial value, same data rate (MCS, Number of Spatial Streams (Nss)) unless the 3^{rd}-party STAs are allocated to the different groups and each group has its own RU where the 3^{rd}-party STAs in the same group follow the similar rules.

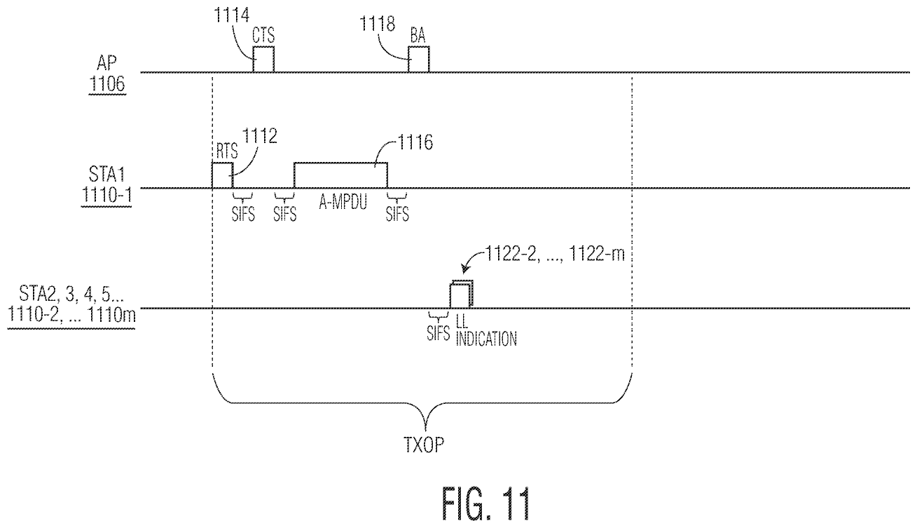

FIG. 11 depicts a frame exchange sequence diagram between an AP 1106, a STA 1110-1, and other STAs 1110-2, . . . , 1110-m, where m is a positive integer that is greater than one. In the embodiment depicted in FIG. 11, the AP 1106 may be implemented the same as or similar to the AP 106 depicted in FIG. 1, while the STAs 1110-1, . . . , 1110-m may be implemented the same as or similar to the STA 110-2, . . . , 110-n depicted in FIG. 1. In the frame exchange sequence diagram depicted in FIG. 11, an RTS 1112 is sent by the STA 1110-1 to reserve the TXOP. After an SIFS, a CTS 1114 is sent by the AP 1106. After an SIFS, an A-MPDU 1116 is sent by the STA 1110-1. After an SIFS, a BA frame 1118 is sent by the AP 1106. After an SIFS, frames 1122-2, . . . , 1122-m with LL indication are sent by the other STAs 1110-2, . . . , 1110-m.

In some embodiments, when multiple 3^{rd} party STAs transmit LL buffered frame indication, the PPDU payloads need to be the same. In some embodiments, the same frame content is implemented. In option 1, CTS-to-Self with AP's basic service set identifier (BSSID) (transmitted BSSID with Multiple BSSID feature) as the receiver address (RA) is implemented. In Option 2, Single MPDU Delimiter with End of Frame (EOF)=0 and Length=0 is implemented. In Option 3, NDP is implemented. In some embodiments, the same MCS or data rate, e.g., MCS 0 or 6 Megabits per second (Mbps), is implemented. In some embodiments, the same Nss, e.g., 1 Spatial Streams SS, is implemented.

In some embodiments, when multiple 3^{rd}-party STAs transmit LL buffered frame indication, the PPDU payloads need to be the same. For example, the same scrambler initialization value is implemented. In Option 1, the scrambler initialization value announced by the AP in the Beacon frame or the other Management frame is implemented. In Option 2, the scrambler initialization value of the single user (SU) PPDU (UHR/EHT MU PPDU with single RU is implemented without MU-MIMO (multi-user, multiple input, multiple output)) SIFS before the LL Buffered Frame Indication transmission. In some embodiments, some 3^{rd}-party STAs may not be able to decode it if the SU PPDU is the UL PPDU. In some embodiments, the scrambler initialization value of the PPDU in the specific RU of the MU PPDU with multiple RUs, e.g. the first RU that covers the primary 20 MHz channel, SIFS before the LL Buffered Frame Indication transmission. In some embodiments, the recipients of the DL MU PPDU may not be able to acquire the scrambler initialization value since they need to decode the RU for them unless all the RUs use the same scrambler initialization value. In some embodiments, the transmitters of the UL MU PPDU may not be able to acquire the scrambler initialization value since they are transmitting frames in their own resource units (RUs). In Option 3, the scrambler initialization value of the SU PPDU if the last DL PPDU is DL SU PPDU before the LL Buffered Frame Indication transmission, i.e. the UL PPDU before the LL Buffered Frame Indication transmission is ignored. In some embodiments, the scrambler initialization value of the PPDU in the specific RU of the MU PPDU with multiple RUs if the last DL PPDU is DL MU PPDU with multiple RUs.

### Example 7: Hidden Node Solution (for Issue #4)

The last PPDU before 3^{rd}-party STAs transmit LL buffered frame indication may be a PPDU transmitted by the AP or the STA(s). The PPDU transmitted by a STA may not be available for some STAs in the same BSS.

In a first solution, if a 3^{rd}-party STA can decode the PPDU that is last PPDU of the frame exchange SIFS before the LL buffered frame indication, the 3^{rd}-party STA can transmit its LL buffered frame indication. In some embodiments, if a 3^{rd}-party STA cannot decode the PPDU that is last PPDU of the frame exchange SIFS before the LL buffered frame indication, the 3^{rd}-party STA cannot transmit its LL buffered frame indication.

In a second solution, when a 3^{rd}-party STA cannot decode the PPDU that is last PPDU of the frame exchange SIFS before the LL buffered frame indication, the 3^{rd}-party STA can still transmit its LL buffered frame indication. In some embodiments, the STA can figure out the last PPDU length per the soliciting PPDU's information (MCS, Nss).

In some embodiments, when the TXOP holder carry the indication of allowing LL preemption in the soliciting PPDU (MAC header or PHY header), the TXOP responder carry the indication of allowing LL preemption in the responding PPDU. In some embodiments, one exception is that the responding PPDU indicates that the AP will do the LL transmission after SIFS in which case the responding PPDU will carry the indication of Continuation of LL Frame Exchange. In some embodiments, when the PHY header carry such indication, the PPDU format of the responding PPDU needs to be UHR PPDU.

In some embodiments, when a STA/AP transmits LL frame whose PPDU carries the indication of the Continuation of LL exchange of the next frame exchange, the responding PPDU carries the same indication. In some embodiments, when the PHY header carry such indication, the PPDU format of the responding PPDU needs to be UHR PPDU.

In some embodiments, in a TXOP the TXOP holder can include the Indication of Allowing LL Preemption in some frame exchange while not include the Indication of Allowing LL Preemption in the other frame exchanges.

In some embodiments, in a TXOP the TXOP holder either includes the Indication of Allowing LL Preemption in all the frame exchanges or do not include the Indication of Allowing LL Preemption in all the frame exchanges.

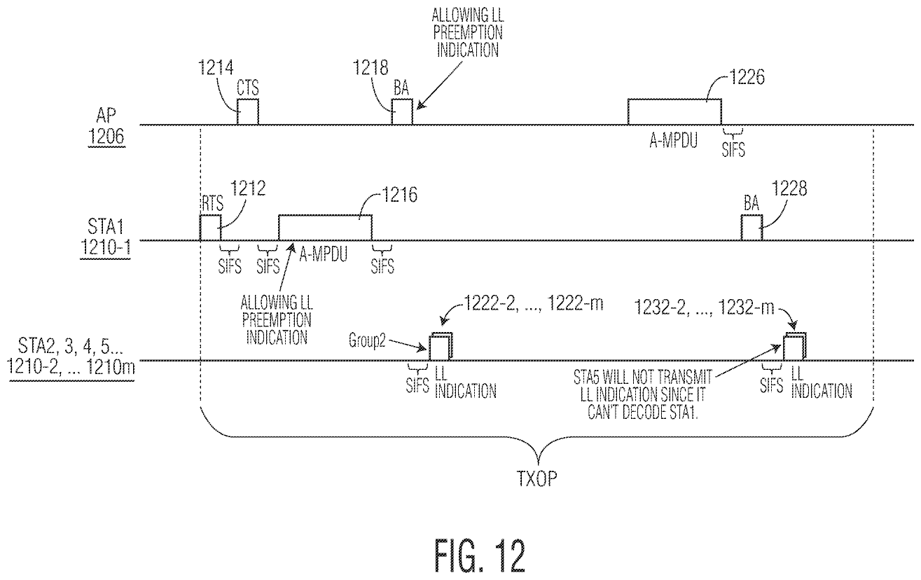

FIG. 12 depicts a frame exchange sequence diagram between an AP 1206, a STA 1210-1, and other STAs 1210-2, . . . , 1210-m, where m is a positive integer that is greater than one. In the embodiment depicted in FIG. 12, the AP 1206 may be implemented the same as or similar to the AP 106 depicted in FIG. 1, while the STAs 1210-1, . . . , 1210-m may be implemented the same as or similar to the STA 110-2, . . . , 110-n depicted in FIG. 1. In the frame exchange sequence diagram depicted in FIG. 12, an RTS 1212 is sent by the STA 1210-1 to reserve the TXOP. After an SIFS, a CTS 1214 is sent by the AP 1206. After an SIFS, an A-MPDU 1216, which may allow LL preemption indication, is sent by the STA 1210-1. After an SIFS, a BA frame 1218, which may allow LL preemption indication, is sent by the AP 1206. After an SIFS, frames 1222-2, . . . , 1222-m with LL indication are sent by the other STAs 1210-2, . . . , 1210-m. Afterward, an A-MPDU 1226 is sent by the AP 1206. After an SIFS, a BA frame 1218 is sent by the STA 1210-1. After an SIFS, frames 1232-2, . . . , 1232-m with LL indication are sent by the other STAs 1210-2, . . . , 1210-m. In some embodiments, the STA 1210-5 does not transmit LL Indication since it cannot decode messages from the STA 1210-1.

### Example 8: TXOP Duration with LL Preemption

In some embodiments, the frame exchanges of LL preemption need to finish within the TXOP indicated by the MAC header or the PHY header of the PPDU SIFS before the LL preemption.

In some embodiments, the frame exchanges of LL preemption can continue after the end of the TXOP indicated by the MAC header or the PHY header of the PPDU SIFS before the LL preemption. In some embodiments, the limit defined by the regulatory needs to be respected.

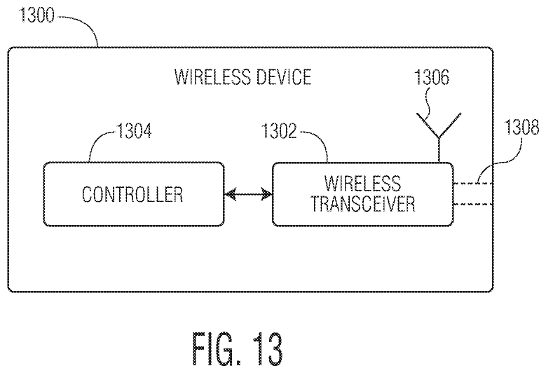

FIG. 13 depicts a wireless device 1300 in accordance with an embodiment of the invention. The wireless device 1300 can be used in the wireless communications system 100 depicted in FIG. 1 and the multi-link communications system 200 depicted in FIG. 2. For example, the wireless device 1300 may be an embodiment of the AP 106 depicted in FIG. 1, the STA 110-1, . . . , 110-n depicted in FIG. 1, the APs 206-1, 206-2 depicted in FIG. 2, the stations STAs 210-1, 210-2 depicted in FIG. 2, the AP 306 depicted in FIG. 3, the stations STAs 310-1, 310-2 depicted in FIG. 3, the AP 406 depicted in FIG. 4, the stations STAs 410-1, 410-2 depicted in FIG. 4, the AP 506 depicted in FIG. 5, the stations STAs 510-1, 510-2 depicted in FIG. 5, the AP 606 depicted in FIG. 6, the stations STAs 610-1, 610-2 depicted in FIG. 6, the AP 706 depicted in FIG. 7, the station STA 710-1 depicted in FIG. 7, the AP 806 depicted in FIG. 8, the stations STAs 810-1, . . . , 810-m depicted in FIG. 8, the AP 906 depicted in FIG. 9, the stations STAs 910-1, . . . , 910-m depicted in FIG. 9, the AP 1006 depicted in FIG. 10, the stations STAs 1010-1, . . . , 1010-m depicted in FIG. 10, the AP 1106 depicted in FIG. 11, the stations STAs 1110-1, . . . , 1110-m depicted in FIG. 11, the AP 1206 depicted in FIG. 12, and/or the stations STAs 1210-1, . . . , 1210-m depicted in FIG. 12. However, the AP 106 depicted in FIG. 1, the STA 110-1, . . . , 110-n depicted in FIG. 1, the APs 206-1, 206-2 depicted in FIG. 2, the stations STAs 210-1, 210-2 depicted in FIG. 2, the AP 306 depicted in FIG. 3, the stations STAs 310-1, 310-2 depicted in FIG. 3, the AP 406 depicted in FIG. 4, the stations STAs 410-1, 410-2 depicted in FIG. 4, the AP 506 depicted in FIG. 5, the stations STAs 510-1, 510-2 depicted in FIG. 5, the AP 606 depicted in FIG. 6, the stations STAs 610-1, 610-2 depicted in FIG. 6, the AP 706 depicted in FIG. 7, the station STA 710-1 depicted in FIG. 7, the AP 806 depicted in FIG. 8, the stations STAs 810-1, . . . , 810-m depicted in FIG. 8, the AP 906 depicted in FIG. 9, the stations STAs 910-1, . . . , 910-m depicted in FIG. 9, the AP 1006 depicted in FIG. 10, the stations STAs 1010-1, . . . , 1010-m depicted in FIG. 10, the AP 1106 depicted in FIG. 11, the stations STAs 1110-1, . . . , 1110-m depicted in FIG. 11, the AP 1206 depicted in FIG. 12, and/or the stations STAs 1210-1, . . . , 1210-m depicted in FIG. 12 are not limited to the embodiment depicted in FIG. 13.

In the embodiment depicted in FIG. 13, the wireless device 1300 includes a wireless transceiver 1302, a controller 1304 operably connected to the wireless transceiver, and at least one antenna 1306 operably connected to the wireless transceiver. In some embodiments, the wireless device 1300 may include at least one optional network port 1308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 1300 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with an embodiment of the invention, the wireless transceiver 1302 is configured to communicate within a transmit opportunity (TXOP), e.g., receiving a frame indicating a preemption allowance for low latency indication frame transmission from a second wireless device, and the controller 1304 is configured to control the wireless transceiver to pause or resume data transmission within the TXOP in response to the frame indicating the preemption allowance for low latency indication frame transmission from the second wireless device. In some embodiments, the wireless device 1300 includes a non-access point (AP) station (STA) device. In some embodiments, the wireless transceiver is further configured to receive, from a wireless access point (AP), the frame indicating the preemption allowance for low latency indication frame transmission from the second wireless device. In some embodiments, the wireless transceiver is further configured to transmit an uplink (UL) physical layer protocol data unit (PPDU) to the wireless AP within the TXOP. In some embodiments, the wireless transceiver is further configured to receive, from the wireless AP, the frame indicating the preemption allowance for low latency indication frame transmission from the second wireless device after the UL PPDU is transmitted to the wireless AP. In some embodiments, the wireless transceiver is further configured to receive a low latency frame from the second wireless device after a low latency indication (LLI) frame is transmitted from the second wireless device. In some embodiments, the wireless transceiver is further configured to receive a frame indicating a preemption release, and the controller is further configured to resume data transmission within the TXOP using the wireless transceiver after the frame indicating the preemption release is received. In some embodiments, the controller is further configured to resume data transmission within the TXOP using the wireless transceiver after a predefined timeout period expires since the frame indicating the preemption allowance for low latency indication frame transmission from the second wireless device without detecting data communications using the wireless transceiver. In some embodiments, both the wireless device and the second wireless device are non-access point (AP) station (STA) devices. In some embodiments, a low latency indication allowance (LIA) bit is set to a specific value in a physical layer (PHY) header of the frame indicating the preemption allowance for low latency indication frame transmission from the second wireless device. In some embodiments, a low latency indication allowance (LIA) bit is set to a specific value in media access control (MAC) control information of the frame indicating the preemption allowance for low latency indication frame transmission from the second wireless device. In some embodiments, the wireless transceiver is further configured to receive low latency buffered frame indications from a plurality of wireless devices using the same frame content, Modulation Coding Scheme (MCS), Number of Spatial Streams (Nss), or scrambling initial value. In some embodiments, the wireless device is compatible with an Institute of Electrical and Electronics Engineers (IEEE) 802.11 protocol. In some embodiments, the wireless device is a component of a multi-link device (MLD).

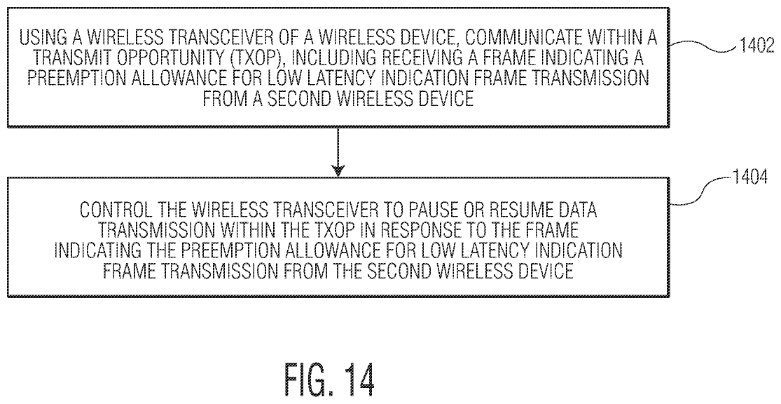

FIG. 14 is a process flow diagram of a method for wireless communications in accordance with an embodiment of the invention. At block 1402, using a wireless transceiver of a wireless device, it is communicated within a transmit opportunity (TXOP), including receiving a frame indicating a preemption allowance for low latency indication frame transmission from a second wireless device. At block 1404, the wireless transceiver is controlled to pause or resume data transmission within the TXOP in response to the frame indicating the preemption allowance for low latency indication frame transmission from the second wireless device. In some embodiments, the wireless device includes a non-access point (AP) station (STA) device. In some embodiments, the frame indicating the preemption allowance for low latency indication frame transmission from the second wireless device is received from a wireless access point (AP). In some embodiments, using the wireless transceiver of the wireless device, an uplink (UL) physical layer protocol data unit (PPDU) is transmitted to the wireless AP within the TXOP. In some embodiments, using the wireless transceiver of the wireless device, a frame indicating a preemption release is received, and data transmission within the TXOP is resumed using the wireless transceiver after the frame indicating the preemption release is received. The wireless device and/or the first wireless device may be the same as or similar to the AP 106 depicted in FIG. 1, the STA 110-1, . . . , 110-n depicted in FIG. 1, the APs 206-1, 206-2 depicted in FIG. 2, the stations STAs 210-1, 210-2 depicted in FIG. 2, the AP 306 depicted in FIG. 3, the stations STAs 310-1, 310-2 depicted in FIG. 3, the AP 406 depicted in FIG. 4, the stations STAs 410-1, 410-2 depicted in FIG. 4, the AP 506 depicted in FIG. 5, the stations STAs 510-1, 510-2 depicted in FIG. 5, the AP 606 depicted in FIG. 6, the stations STAs 610-1, 610-2 depicted in FIG. 6, the AP 706 depicted in FIG. 7, the station STA 710-1 depicted in FIG. 7, the AP 806 depicted in FIG. 8, the stations STAs 810-1, . . . , 810-m depicted in FIG. 8, the AP 906 depicted in FIG. 9, the stations STAs 910-1, . . . , 910-m depicted in FIG. 9, the AP 1006 depicted in FIG. 10, the stations STAs 1010-1, . . . , 1010-m depicted in FIG. 10, the AP 1106 depicted in FIG. 11, the stations STAs 1110-1, . . . , 1110-m depicted in FIG. 11, the AP 1206 depicted in FIG. 12, and/or the stations STAs 1210-1, . . . , 1210-m depicted in FIG. 12. The wireless AP may be the same as or similar to the AP 106 depicted in FIG. 1, the APs 206-1, 206-2 depicted in FIG. 2, the AP 306 depicted in FIG. 3, the AP 406 depicted in FIG. 4, the AP 506 depicted in FIG. 5, the AP 606 depicted in FIG. 6, the AP 706 depicted in FIG. 7, the AP 806 depicted in FIG. 8, the AP 906 depicted in FIG. 9, the AP 1006 depicted in FIG. 10, the AP 1106 depicted in FIG. 11, and/or the AP 1206 depicted in FIG. 12.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a wireless transceiver configured to communicate within a transmit opportunity (TXOP), wherein the wireless transceiver is further configured to receive a frame indicating a preemption allowance for low latency indication frame transmission from a second wireless device; and
a controller configured to control the wireless transceiver to pause or resume data transmission within the TXOP in response to the frame indicating the preemption allowance for low latency indication frame transmission from the second wireless device.

2. The wireless device of claim 1, wherein the wireless device comprises a non-access point (AP) station (STA) device.

3. The wireless device of claim 1, wherein the wireless transceiver is further configured to receive, from a wireless access point (AP), the frame indicating the preemption allowance for low latency indication frame transmission from the second wireless device.

4. The wireless device of claim 3, wherein the wireless transceiver is further configured to transmit an uplink (UL) physical layer protocol data unit (PPDU) to the wireless AP within the TXOP.

5. The wireless device of claim 4, wherein the wireless transceiver is further configured to receive, from the wireless AP, the frame indicating the preemption allowance for low latency indication frame transmission from the second wireless device after the UL PPDU is transmitted to the wireless AP.

6. The wireless device of claim 1, wherein the wireless transceiver is further configured to receive a low latency frame from the second wireless device after a low latency indication (LLI) frame is transmitted from the second wireless device.

7. The wireless device of claim 1, wherein the wireless transceiver is further configured to receive a frame indicating a preemption release, and wherein the controller is further configured to resume data transmission within the TXOP using the wireless transceiver after the frame indicating the preemption release is received.

8. The wireless device of claim 1, wherein the controller is further configured to resume data transmission within the TXOP using the wireless transceiver after a predefined timeout period expires since the frame indicating the preemption allowance for low latency indication frame transmission from the second wireless device without detecting data communications using the wireless transceiver.

9. The wireless device of claim 1, wherein both the wireless device and the second wireless device are non-access point (AP) station (STA) devices.

10. The wireless device of claim 1, wherein a low latency indication allowance (LIA) bit is set to a specific value in a physical layer (PHY) header of the frame indicating the preemption allowance for low latency indication frame transmission from the second wireless device.

11. The wireless device of claim 1, wherein a low latency indication allowance (LIA) bit is set to a specific value in media access control (MAC) control information of the frame indicating the preemption allowance for low latency indication frame transmission from the second wireless device.

12. The wireless device of claim 11, wherein the wireless transceiver is further configured to receive low latency buffered frame indications from a plurality of wireless devices using the same frame content, Modulation Coding Scheme (MCS), Number of Spatial Streams (Nss), or scrambling initial value.

13. The wireless device of claim 1, wherein the wireless device is compatible with an Institute of Electrical and Electronics Engineers (IEEE) 802.11 protocol.

14. The wireless device of claim 1, wherein the wireless device is a component of a multi-link device (MLD).

15. A non-access point (AP) station (STA) device comprising:
a wireless transceiver configured to communicate within a transmit opportunity (TXOP), wherein the wireless transceiver is further configured to receive, from a wireless AP, a frame indicating a preemption allowance for low latency indication frame transmission from a second non-AP STA device, wherein a low latency indication allowance (LIA) bit is set to a specific value in a physical layer (PHY) header of the frame indicating the preemption allowance for low latency indication frame transmission from the second wireless device; and
a controller configured to control the wireless transceiver to pause or resume data transmission within the TXOP in response to the frame indicating the preemption allowance for low latency indication frame transmission from the second non-AP STA device.

16. A method for wireless communications, the method comprising:
using a wireless transceiver of a wireless device, communicating within a transmit opportunity (TXOP), including receiving a frame indicating a preemption allowance for low latency indication frame transmission from a second wireless device; and
controlling the wireless transceiver to pause or resume data transmission within the TXOP in response to the frame indicating the preemption allowance for low latency indication frame transmission from the second wireless device.

17. The method of claim 16, wherein the wireless device comprises a non-access point (AP) station (STA) device.

18. The method of claim 16, wherein receiving the frame indicating the preemption allowance for low latency indication frame transmission from the second wireless device comprises receiving, from a wireless access point (AP), the frame indicating the preemption allowance for low latency indication frame transmission from the second wireless device.

19. The method of claim 18, further comprising using the wireless transceiver of the wireless device, transmitting an uplink (UL) physical layer protocol data unit (PPDU) to the wireless AP within the TXOP.

20. The method of claim 16, further comprising receiving a frame indicating a preemption release, and wherein pausing or resuming data transmission within the TXOP using the wireless transceiver in response to the frame indicating the preemption allowance for low latency indication frame transmission from the second wireless device comprises resuming data transmission within the TXOP using the wireless transceiver after the frame indicating the preemption release is received.
